(19) United States
(12) Patent Application Publication
(10) Pub. No.: US 2003/0041327 A1
(43) Pub. Date: Feb. 27, 2003

(54) System with improved user interface

(76) Inventors: Philip Steven Newton, Eindhoven (NL); Wilhelmus Henrica Gerarda Maria Van Den Boomen, Eindhoven (NL); Andrew James Hickman, London (GB); Johannes Antonius Jansen, London (GB); Wee Keng Koh, South Buckinghamshire (GB); Jeroen Ronald Johannes Van Der Putten, Eindhoven (NL); Jiska Margriet De Wit, Eindhoven (NL); Gerhardus Engbertus Mekenkamp, Eindhoven (NL)

Correspondence Address: U.S. Philips Corporation, 580 White Plains Road, Tarrytown, NY, 10591, US

(21) Appl. No.: 10/225,117

(22) Filed: Aug. 21, 2002

(30) Foreign Application Priority Data
Aug. 24, 2001 (EP) 01203202.5

(51) Int. Cl. H04N 9/79; G06F 3/00; H04N 5/445; G06F 13/00

(52) U.S. Cl. 725/44; 725/37; 386/35

(57) ABSTRACT

A system with an improved user interface for managing a collection (201) of content items such as television programs. The system manages three types of content: recorded content items (501), content items scheduled for recording (601), and content items (701) that have not been recorded and are not scheduled for recording either. These three types are managed using separate user interface layers: a browse layer (500), a discovery layer (600), and a wish layer (700) respectively. Additionally, a watch layer (400) is provided as an entry to the system. This layer (400) allows managing of content using the concept of a personal channel (401).

The invention relates to a system, a computer program product and a user interface for managing a collection of content items.

As the number of channels available to television viewers has increased, along with the diversity of the programming content available on such channels, it has become increasingly challenging for television viewers to identify television programs of interest. Historically, television viewers identify television programs of interest by analyzing printed television program guides. As the number of television programs has increased, it has become increasingly difficult to effectively identify desirable television programs using such printed guides.

More recently, television program guides have become available in electronic format, often referred to as electronic program guides (EPGs). Like printed television program guides, EPGs present overviews of the available television programs, which can be browsed by the user.

The EPG compiles the overview from metadata that accompanies the individual content items. This metadata generally comprises information such as title, artist, genre and so on, and generally also contains a unique content reference ID, a so-called CRID. Using the CRID, each individual content item can be uniquely identified. Further, using the CRID further information can be retrieved from a database. For example, a user can select a content item which he wishes to see from the EPG, even though the time and place of broadcast are not yet known. Using the CRID, the system can then retrieve the time and place of broadcast of the content item when this information becomes available.

When the user, based on the metadata, wants to record a content item, the system tries to obtain the location of the content item. This information is called a locator and it contains the date, time and channel on which the content item will be broadcast. The user however does not need to be aware of this. Once the system has found the locator of the content item, the locator is stored in the metadata.

The amount of metadata on content available to the user in such a system can be huge. For example, in a television system with 200 channels and 20 programs per channel per day, 28,000 programs are available in the EPG for the upcoming week. It is clear that the main challenge of any implementation of such a television system is to make finding the desired content easy and straightforward.

It is an object of the invention to provide a system according to the preamble, which is easier to use than known systems.

This object is achieved according to the invention in a system comprising:

personal channel maintenance means for scheduling a subset of one or more content items of said collection for presentation in a personal channel,

recording maintenance means for managing previously recorded content items of said collection,

schedule maintenance means for managing content items of said collection that are presently scheduled for recording, and

wish management means for managing content items of said collection that were not previously recorded and are not presently scheduled for recording.

The invention is based, amongst other things, on the insight that there are three types of content available: content whose locator is not yet known, content where the locator is known but which has not yet been recorded, and content that has been recorded. Distinguishing between these different types of content can be difficult for the user. It is therefore important that the system provides an easy and straightforward way to manage these different types of content.

The concept of personal channels is used as an entry to the system. The user can now quickly see which content items are scheduled for presentation, review and edit their mutual order and add and remove content items from the personal channel, regardless of type.

Separate management interfaces are provided for managing recorded content items and content items that have not yet been recorded that are scheduled for recording. This way, the user does not get confused about the operations which he can perform on either of the types. If these two types of content items are mixed, the user expects that he will be able to perform the same operations on both types of content, even though this is not in fact the case. By providing separate means for managing recorded content items and content items scheduled for recording, usability of the system is improved.

The third type of content, content for which the location is not yet known, is also managed by a separate interface. Using this interface, the user can amongst other things search for content items which he wishes to see and which are not yet available as recording or scheduled for recording. If locator information is available for these items, they can then be scheduled for recording. Otherwise they are added to a wish list and scheduled as soon as locator information becomes available.

In an embodiment managing recorded content items or content items scheduled for recording comprises at least adding and removing said content items to and from the subset. This way, the separate interfaces for recorded and scheduled content also allow managing the subset of the collection used in the personal channel, at least insofar as it concerns the respective type of content they manage.

In a further embodiment the wish management means are arranged for locating a further content item and adding it to the collection. This allows the user to easily extend. the collection of available content items.

In a variant of this embodiment the wish management means are arranged for searching for the further content item in a database remote from the system. In particular, external databases such as those available on the Internet provide a very large source of information on content items, making them very suitable as a source of information.

In a further embodiment the wish management means are arranged for managing only those content items of the collection for which no locator information is available. Content items for which no locator information is available is a type of content different from recorded content items and content items scheduled for recording. This type of content therefore needs to be handled differently from those other two types of content. It is therefore advantageous to provide a separate interface for doing so.

In a further embodiment the wish management means are arranged for automatically scheduling a content item for recording upon receipt of locator information for the content item. As soon as locator information becomes available, a previously unscheduled content item can now be scheduled. Since the user has previously added this content item to the collection, he probably wants to see it, so it is recommended to now automatically scheduling for recording.

In a further embodiment the personal channel maintenance means are arranged for scheduling the content items in the subset independently of any timing information associated with said content items. When content items have been recorded, or scheduled to be recorded in the near future, they can of course be played back in any order, assuming the recording medium provides random access to the recordings. By scheduling the content items in the personal channel independently of timing information, the user is given the opportunity to view these content items exactly how he wants them.

The invention further relates to a television receiver comprising the system according to the invention. It will be evident that the system as described above is particularly advantageous when used in a television receiver, since managing a large number of television programs is particularly desirable. The system according to the invention can be realized as a computer program product that can be loaded in a programmable device to cause said device to function as a system according to the invention.

It is a further object of the invention to provide a user interface according to the preamble, which is easier to use than known interfaces.

This object is achieved according to the invention in a user interface comprising

a watch layer for scheduling a subset of one or more content items of said collection for presentation in a personal channel,

a browse layer for managing previously recorded content items of the collection,

a discovery layer for managing content items of said collection that are presently scheduled for recording, and

a wish layer for managing content items of said collection that were not previously recorded and are not presently scheduled for recording.

As explained above, there are three different types of content items that need to be managed. The browse layer allows managing of the recorded content items, the discovery layer allows managing scheduled content items, and the wish layer allows managing unrecorded and unscheduled content items, as well as adding new content items to the collection. The watch layer provides an easy interface to organizing those items of the collection that the user wants to see.

These and other aspects of the invention will be apparent from and elucidated with reference to the embodiments shown in the drawing, in which:

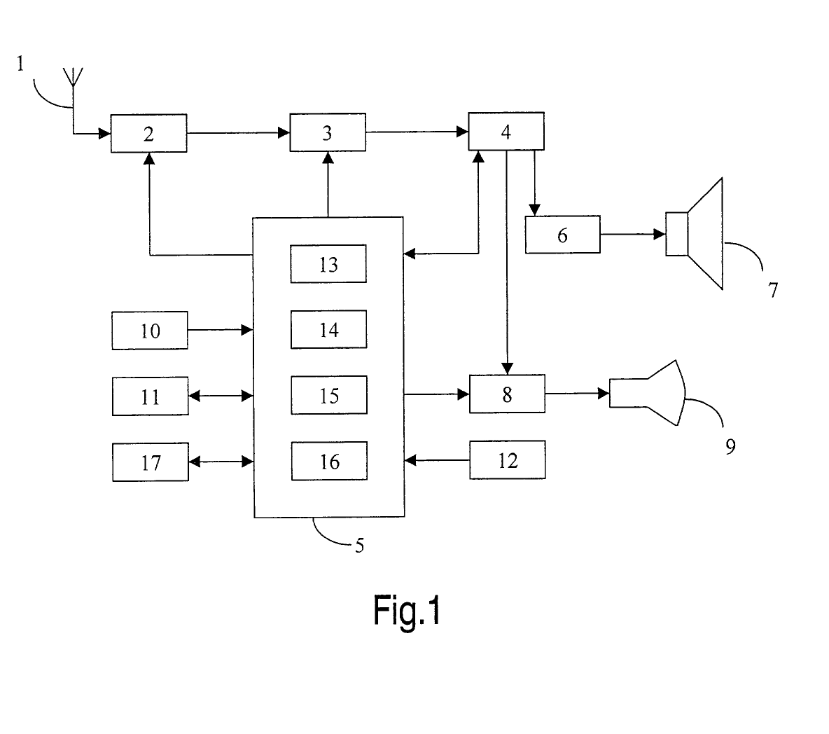

FIG. 1 schematically shows a television receiver comprising a system according to the invention;

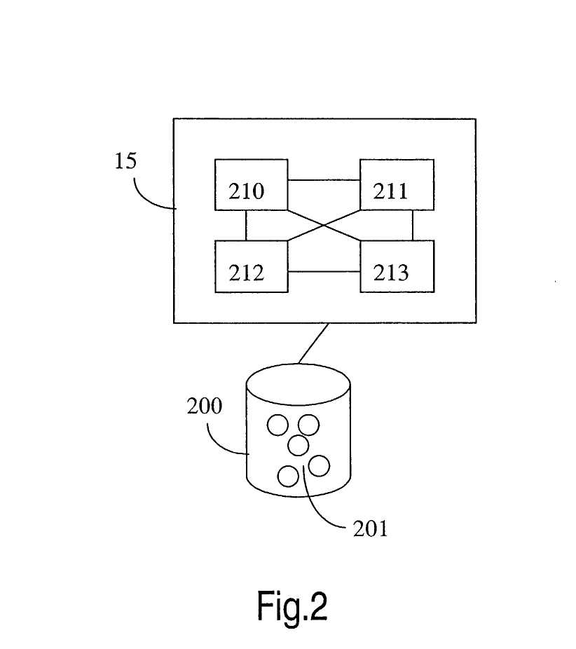

FIG. 2 schematically shows the content management module of the system in more detail;

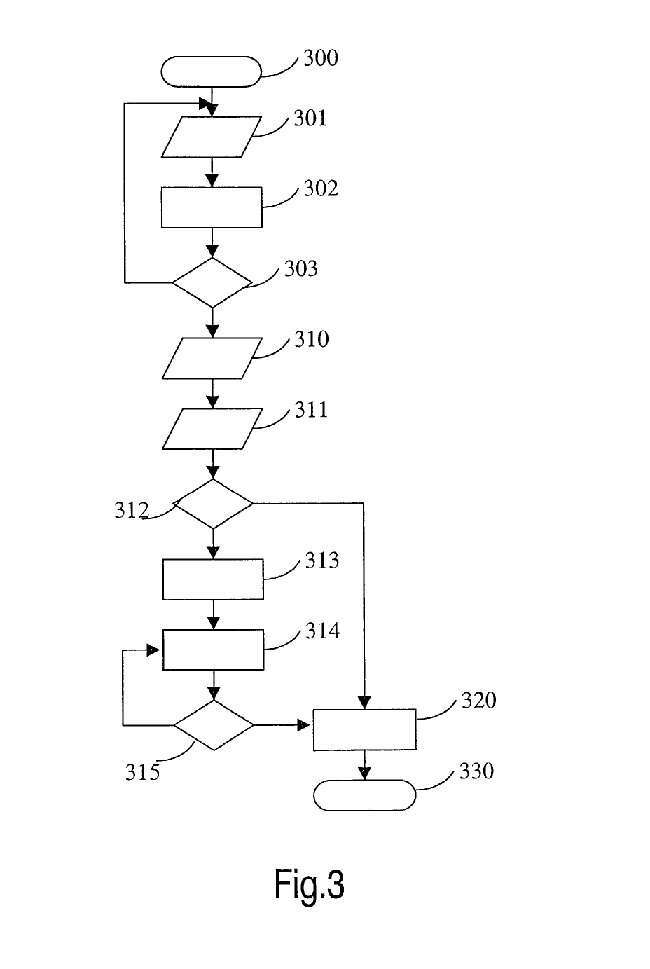

FIG. 3 shows a flowchart illustrating the procedure for managing new content;

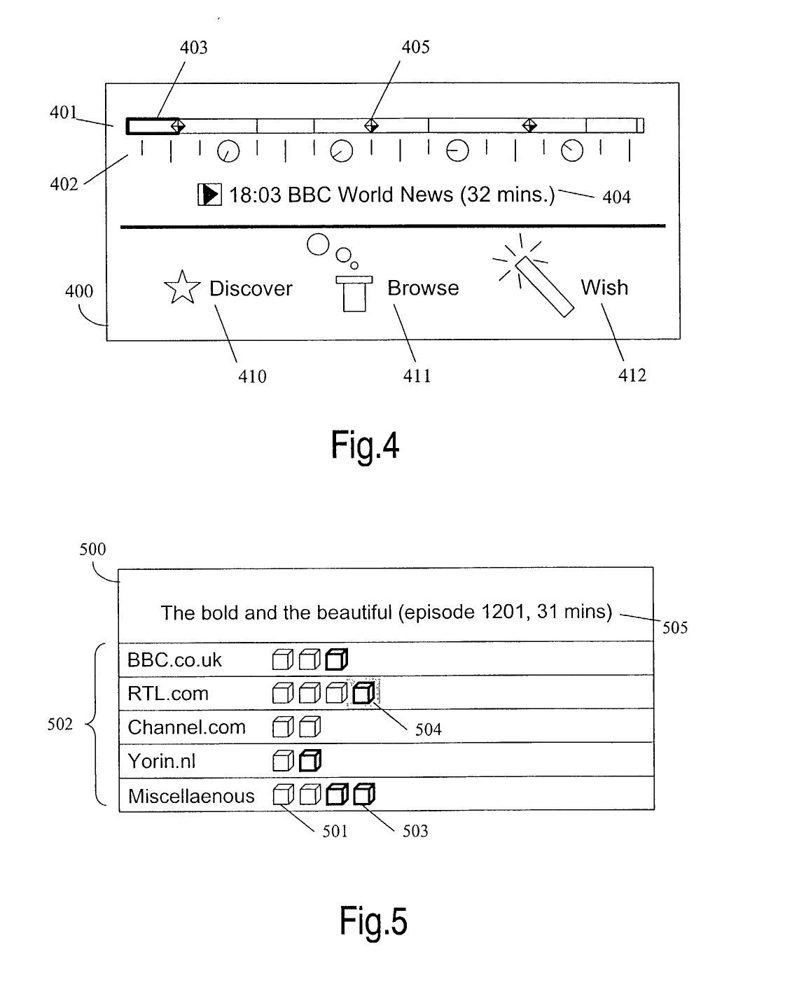

FIG. 4 shows an embodiment of the watch layer of the user interface of the system;

FIG. 5 shows an embodiment of the browse layer of the user interface;

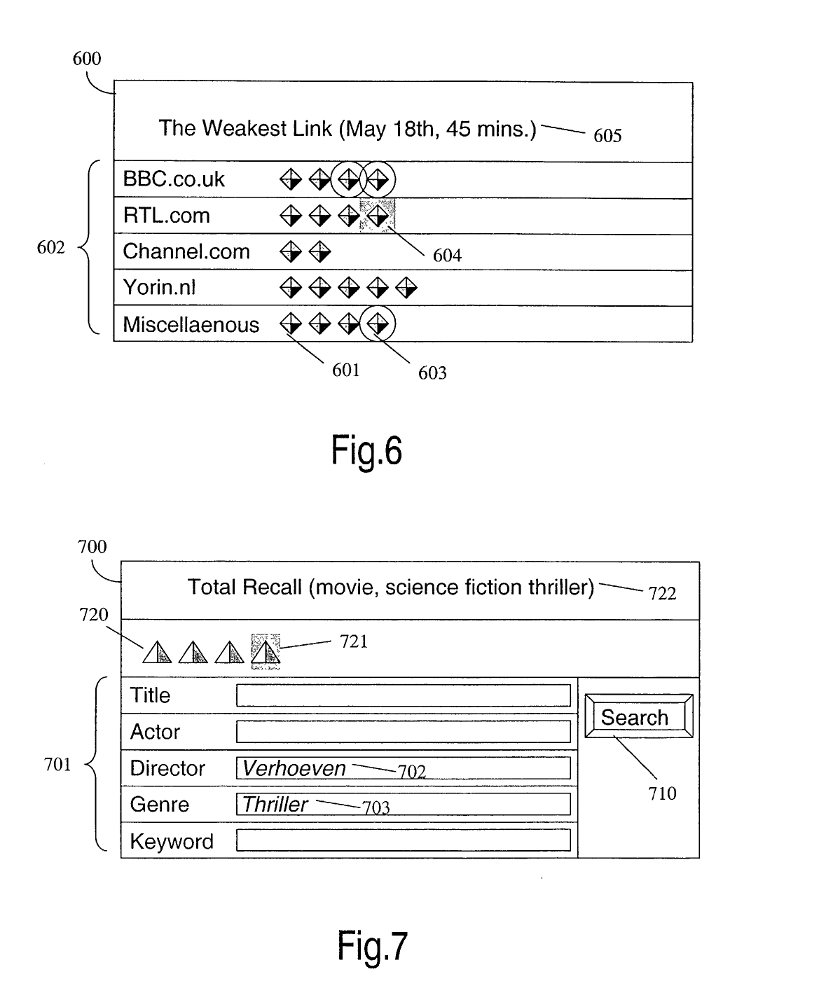

FIG. 6 shows an embodiment of the discovery layer of the user interface; and

FIG. 7 shows an embodiment of the wish layer of the user interface.

Throughout the figures, same reference numerals indicate similar or corresponding features. Some of the features indicated in the drawings are typically implemented in software, and as such represent software entities, such as software modules or objects.

FIG. 1 schematically shows a television receiver comprising a system according to the invention. Digital broadcast streams, modulated upon radio frequency (RF) signals, are received from the ether by an antenna 1, or, alternatively, from a cable network or another source.

The broadcast streams may be formatted, for example, in accordance with the Digital Video Broadcasting (DVB) standard. A tuner 2 comprises a standard analog RF receiving device which is capable of receiving said RF signals and selecting one of them to be output to a demodulator 3. Which signal the tuner 2 receives depending upon control data received from a central processing unit (CPU) 5. The demodulator 3 converts the analog signal into a digital packet stream, based on the control signals received from the CPU 5. This packet stream is then output to a demultiplexer 4, which selects packets belonging to a particular program in accordance with control data received from the CPU 5, and decomposes the packet stream into elementary audio, video or data streams.

In addition to broadcast signals, the television receiver may be adapted to receive signals from other sources too, for example, from a (digital) video recorder or DVD player, from the internet, or from a digital subscriber line. Programs and program attributes (metadata) need not be obtained from the same source. For example, attribute and attribute values relating to broadcast programs may be obtained from an internet site.

A video processor 8 decodes the video stream received from the demultiplexer 4 or from the CPU 5. Decoded video data is then transmitted to a display screen 9. An audio processor 6 decodes the audio stream received from the demultiplexer 4. Decoded audio data is then transmitted to a speaker system 7.

The demultiplexer 4 outputs the elementary data stream to the CPU 5. The elementary data stream has two types of data: control data and content data. Content refers to, for example, interactive programs; control refers to tables in the multiplex which specify matters like the structure of the multiplex, the (RF) frequencies at which the channels are modulated, and the addresses at which the various content components and the (other) tables in the multiplex can be found. The CPU 5 comprises one or more microprocessors capable of executing program instructions stored in a read-only memory (ROM) 12.

Alternatively, program instructions may be stored in a random-access memory such as a hard disk. These program instructions comprise parts of software modules including, inter alia, a command module 13, and a preference profile module 14. Data processed by said software modules, e.g. DVB-SI data and preference profile information, may be stored in a non-volatile memory 11. The command module 13 is capable of controlling functions of the television receiver, like tuning and demultiplexing a selection, and transmitting data to the video processor 8 to be presented on the screen 9.

A user command unit 10 receives user commands, e.g. through a remote control (not shown), and transmits them to the command module 13 to be processed. For example, when the user enters a channel number, the command module 13 controls the tuner 2 and the demultiplexer 4 to select the corresponding broadcast stream and data packets therein, and sends graphical data to the video processor 8 to present feedback on the screen 9, e.g. the present number, the channel name being displayed for a few seconds.

The preference profile module 14 interprets the program attributes, for example received as DVB-SI data from the demultiplexer 4 to collect information about the channels, or “services” in DVB terminology, which are available in the received broadcast streams and about the programs, or “events” in DVB terminology, which are scheduled for those channels.

The preference profile module 14 may be arranged to learn from the user's viewing behavior. For example, the preference profile module 14 could receive the commands from the command module 13 and determine from that which programs the user finds interesting. The preference profile module 14 records the user's preferences and interest in a preference profile for that user. The preference profile module 14 may maintain a collection of preference profiles, for different users or for different situations. For example, a sports profile as well as a movies profile could be maintained for one user.

It is to be expected to that the various sources mentioned above will make a very large number of programs, or, more generally, content items, available. To manage all these content items, a content management module 15 is available.

FIG. 2 schematically shows the content management module 15 in more detail. Metadata about a collection 201 of content items is stored on a storage medium 200. For each content item in the collection 201, data such as title, genre, actor and so on is maintained.

A very important piece of metadata is the unique content reference identifier (CRID). This identifier uniquely identifies a content item, and it is necessary for every content item to have a CRID so that it can be managed by the content management module 15. This means that, for example, a Web server making metadata of content items available must include the CRID in its response to the content management module 15. A content item may have more than one CRID, for instance to distinguish between versions of a movie subtitled in different languages.

The metadata can be provided by different parties. This makes it possible to receive information from multiple sources for one and the same content item. The CRID can then be used to merge and/or synchronize this information. Users can subscribe to a service which provides metadata. The metadata is then downloaded into the system, forming the collection 201.

Another important piece of metadata for a content item is the locator: the date, time and channel on which the content item will be broadcast, or in general the location in which the item can be accessed. A content item may have more than one locator, for example if it is broadcast multiple times or available from multiple providers.

This locator information is not necessarily always available. For example, the collection 201 may comprise metadata for a movie that has only recently been released in movie theaters. This movie is not likely to be broadcast on television in the near future, so it cannot be scheduled using EPG information. However, when it eventually makes it to television, the user would like to record it. Hence the metadata is included in a collection 201. This metadata will include the CRID for the movie. This way, the system can later correlate locator information to other metadata for the movie.

Metadata for content items is available from a variety of sources. Metadata can be included with the broadcast stream, e.g. as MPEG-2 tables, or downloaded from external databases. For example, the television receiver may be provided with an Internet connection, which allows the content management module 15 to access metadata made available over the World Wide Web.

Content items for which locator information is available can be recorded by the television receiver. To this end, the television receiver may comprise local storage such as a sufficiently large hard disk, and/or a device such as a DVD-RW writer. The storage on which content items are stored needs not be local to the television receiver, but may also be an external device such as a video recorder or a file server connected to the television receiver via a home network. Once the content items have been recorded, they can be played back at any time until they have been erased.

In some systems it is even possible to play back a content item which is presently being recorded. The system then needs information from the beginning of the recording and plays it back, and at the same time writes information to the end of the recording. This is known for example in the commercially available TiVo™ television system.

Content items in the collection 201 that have not yet been recorded may or may not be scheduled for recording. A collection 201 may comprise a very large number of content items. It would be undesirable to record them all. Rather, using the user profile maintained by the preference profile module 14, the collection manager 15 can schedule for recording only those content items from the collection 201 which the user is likely to appreciate.

To allow effective management of the content items in the collection 201, the content management module 15 according to the invention employs a multi-layered user interface. In this user interface different types of content are accessed via different layers or views. The ordering of the layers is such that the control the user has over the system increases with each layer. The first layer, referred to as to watch layer, is the easiest to understand for novice users. As the user gets more experienced in using the system, he can start using the browse, discovery and wish layers.

To realize the multi-layered user interface, several modules are provided. A personal channel maintenance module 210 realizes the watch layer. A recording maintenance module 211 realizes the browse layer. A schedule maintenance module 212 realizes the discovery layer. A wish management module 213 realizes the wish layer. These will be discussed below.

The personal channel maintenance module 210 creates and maintains a virtual channel, also known as a personal channel, for reproducing programs that match a preference profile as maintained by the preference profile module 14. If there are multiple preference profiles, the module 210 of course can maintain multiple virtual channels, one for each preference profile. When the user switches to the personal channel, the personal channel maintenance module 210 arranges for the correct content items to be presented on the display 9 of the television receiver.

The concept of virtual channels by itself is known from international patent application WO 00/40012 (attorney docket PHN 17268) by the same applicant as the present application. A personal channel is a set of content items including recorded items that match to a high degree with the preference profile associated with the personal channel, future items that match to a high degree with the preference profile, and future items that match to a lesser high degree, but that are still assumed to be of interest. The user can switch to the personal channel and then view only the programs that match the associated preference profile.

This personal channel contains a set of content items that have been recorded and content items that are scheduled for recording. This set is a subset of the collection 201. Content items in the subset may be scheduled based on original timing information, for example the eight o'clock news before the ten o'clock news. However it may also be desirable to schedule the content items in the subset independently of any timing information associated with subset content items. After all, when all the content items are available from local storage, there is no reason why they should be played back in any particular mutual order.

An example embodiment of the watch layer of the user interface is shown in FIG. 4. The watch layer 400 shows a set of one more content items scheduled for presentation in a personal channel as a horizontal bar 401. Below the bar 401 timing information 402 is schematically indicated. The user can select a content item from the bar 401, as indicated by selection 403. Metadata 404 of the selected content item 403 is being displayed. The user can perform various operations on the selected content item 403, such as removing it from the personal channel, give it a rating or immediately starting playback.

Content items which have not been recorded yet cannot be played back. To allow the user to still get an idea of what those content items are about, a preview indicated by diamond 405 can be provided instead. The user can then examine the preview to decide whether he wants that content item recorded or not.

The watch layer 400 also provides buttons 410, 411 and 412 which give access to respective other layers of the user interface.

Returning to FIG. 2, a recording maintenance module 211 is provided for managing previously recorded content items of the collection 201. The recording maintenance module 211 provides a simple means of selecting and browsing through stored content items. An embodiment of the user interface layer of the recording maintenance module 211 is shown in FIG. 5. This layer is known as the browse layer.

The browse layer 500 displays the stored content and allows the user to browse through the content. Once the user has identified the piece of content that he wishes to view, he can select the content to play now or he can place it in the personal channel in any time slot. The user can also remove recorded content items from the personal channel.

In this embodiment, the recorded content items are represented as boxes 501 and grouped by channel 502. Of course recorded content items can also be grouped by genre or by any other selection criterion. Some of the recorded content items are part of the personal channel. These are shown as boxes 503 with thicker lines. The user can select a content item, in this case content item 504, and he can then view metadata 505 for the selected content item 504. Further functions offered by the browse layer may include grouping content items, viewing individual segments of the content item and viewing make a data for stored content items.

There are of course a great many more functions that can be provided for managing stored content items. For example a visual table of contents of all stored content items can be generated and displayed. The system could also identify key frames in the selected content item and display those to give a quick overview of what the selected content item is about. One method of doing so is described in co-pending international patent application PCT/IB02/01279 (attorney docket PHNL010254) by the same applicant as the present application.

Returning once more to FIG. 2, a schedule maintenance module 212 is provided for managing content items of the collection 201 that are presently scheduled for recording. An embodiment of the user interface layer for the schedule maintenance module 212 is shown in FIG. 6. This layer is known as the discovery layer.

The discovery layer 600 displays the content items scheduled for recording and allows the user to browse through it. The user can cancel the recording of content items presented here. The user can also add and remove content items to and from the personal channel, although it is of course impossible to present those content items since they have not yet been recorded. It may be desirable to limit this function, or to remove it altogether.

Similarly to the browse layer 500, the discovery layer 600 shows content items scheduled for recording, here represented as diamonds 601, and grouped by channel 602. Of course the content items can also be grouped by genre or by any other selection criterion. If some scheduled content items are included in the personal channel, this is indicated by a circle around such a content item 603.

The user can select a content item, in this case content item 604, and he can then view metadata 605 for the selected content item 604. The user can also enter or modify a rating for the selected content item 604. This rating is incorporated into his preference profile as maintained by this preference profile module 14. It may happen that, due to a very low rating given by the user, recording of the content item 604 is cancelled.

When the content item is actually recorded, it is removed from the discovery layer 600 and appears in the browse layer 500. The user may be given the option to prevent recording of a particular content item. The content item will then remain in the discovery layer 600, preferably together with a special flag to indicate its special status.

Returning to FIG. 2 one last time, the content management module 15 also includes a wish management module 213. This module 213 manages content items of the collection 201 that have not yet been recorded and that are not scheduled for recording either. That is, those content items that are not managed by either the recording maintenance module 211 or the schedule maintenance module 211. An embodiment of the user interface layer for the wish management module 213 is shown in FIG. 7. This layer is known as the wish layer.

Because of the potentially large amount of content items in the collection 201, the wish layer 700 basically works like a search engine. The wish layer 700 provides a set of parameters 701, such as title, actor, director, genre or keyword. The user can enter values 702, 703 for one more of the parameters 701 to search for content items that matches the values 702, 703. He can then effect a search 210, e.g. by pressing a button on the display.

From the search results the user can select one more content items that he wishes to see (hence the name wish layer). Several such content items 720 are shown in FIG. 7. Similarly to the browse layer 500 and the discovery layer 600 above, the user can select a content item 721 to view metadata 722 about the selected content item 721.

FIG. 3 shows a flowchart illustrating the procedure for managing new content as followed by the wish management module 213. The method begins at step 300, when the user activates the wish management module 213. As explained above, the wish layer 700 is presented to the user, allowing him to input values for parameters 701.

At step 301, the values input by the user are received. These values are then used as a query for a database search in step 302. The search 710 can be executed on the local database 200 with metadata, but can also be executed on some external database. For example, a search could be performed in a database available over the Internet. This way, many different information providers can supply metadata of content items to users of these television systems. If at step 303 no results were returned, the method returns to step 301, allowing the user to supply new values or correct the ones he input before.

If at step 303 one of more results were returned, the results are then presented to the user in step 310. The results of the search 710 are displayed to the user. This could be done in a fashion similar to the display of content items in the browse layer 500 or the discovery layer 600. In FIG. 7 content items 720 are shown as triangles to distinguish them from recorded content items 501, which are shown as boxes, and content items 601 scheduled for recording, which are shown as diamonds.

The user can then input a selection from the results in step 311 to indicate that he wishes to view the selected content item. Upon receiving the selection, the wish maintenance module 213 determines at step 312 whether locator information is available for the selected content item. Of course, the user can also input a selection comprising multiple content items in step 311. Step 312 must then be repeated for every content item in the selection.

As stated above, locator information identifies the time and place at which the selected content item is or will be available. For example, it may identify the channel and the time at which selected content items will be broadcast. It may also comprise an Internet URL. Without locator information, the selected content item cannot be recorded.

If at step 312 it was determined that locator information is available, then the selected content item is scheduled for recording at step 320, after which the method is complete 330. The selected content item will then become visible in the discovery layer 600.

If no locator information is available, then the selected content item cannot be scheduled for recording. So, the selected content item is then maintained 313 in the wish layer 700. The wish management module 213 can at step 314 try to obtain locator information for the selected content item maintained in the wish layer 700. If such locator information becomes available, then at step 315 the wish management model 213 can proceed to step 320. If not, the module 213 must wait until it does.

The locator information can also be supplied at regular intervals to the wish management module 213 where it can be correlated with the content items of the collection 201 using the unique CRID present in both the locator information and the metadata in the collection 201. Should at the later time the user select a content item from the collection 201 for which locator information was previously received, then that content item can immediately be scheduled for recording.

The system according to the invention can, in addition to a television receiver, be realized as a set-top box or a (digital) video recorder. The system can also be realized for example in a hand-held remote control such as the Pronto™, or in another hand-held device. The system can also be realized as a computer program product being arranged for causing a processor to execute the steps described above. The computer program product enables a programmable device to function as the system according to the invention.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A system for managing a collection of content items, comprising
personal channel maintenance means for scheduling a subset of one or more content items of said collection for presentation in a personal channel,
recording maintenance means for managing previously recorded content items of said collection,
schedule maintenance means for managing content items of said collection that are presently scheduled for recording, and
wish management means for managing content items of said collection that were not previously recorded and are not presently scheduled for recording.

2. The system of claim 1, wherein managing recorded content items or content items scheduled for recording comprises at least adding and removing said content items to and from the subset.

3. The system of claim 1, in which the wish management means are arranged for locating a further content item and adding it to the collection.

4. The system of claim 3, in which the wish management means are arranged for searching for the further content item in a database remote from the system.

5. The system of claim 1, in which the wish management means are arranged for managing only those content items of the collection for which no locator information is available.

6. The system of claim 5, in which the wish management means are arranged for automatically scheduling a content item for recording upon receipt of locator information for the content item.

7. The system of claim 1, in which the personal channel maintenance means are arranged for scheduling the content items in the subset independently of any timing information associated with said content items.

8. A television receiver comprising the system of claim 1.

9. A computer program product for managing a collection of content items, comprising
personal channel maintenance means for scheduling a subset of one or more content items of said collection for presentation in a personal channel,
recording maintenance means for managing previously recorded content items of the collection,
schedule maintenance means for managing content items of said collection that are presently scheduled for recording, and
wish management means for managing content items of said collection that were not previously recorded and are not presently scheduled for recording.

10. A user interface for managing a collection of content items, comprising
a watch layer for scheduling a subset of one or more content items of said collection for presentation in a personal channel,
a browse layer for managing previously recorded content items of the collection,
a discovery layer for managing content items of said collection that are presently scheduled for recording, and
a wish layer for managing content items of said collection that were not previously recorded and are not presently scheduled for recording.
